(19) United States
(12) Patent Application Publication
(10) Pub. No.: US 2014/0111470 A1
(43) Pub. Date: Apr. 24, 2014

(54) THREE-DIMENSIONAL TOUCH DISPLAY PANEL AND METHOD FOR OPERATING THE SAME

(71) Applicant: HannStar Display Corp., New Taipei City (TW)

(72) Inventors: Hsu-Ho Wu, Tainan City (TW); Chia-Hua Yu, New Taipei City (TW); I-Fang Wang, Changhua County (TW); Kun-Cheng Lee, Tainan City (TW); Feng-Wei Kuo, Pingtung County (TW); Heng-Cheng Tseng, Chiayi County (TW); Mu-Kai Kang, Pingtung County (TW); Guang-Shiung Chao, Kaohsiung City (TW)

(73) Assignee: HannStar Display Corp., New Taipei City (TW)

(21) Appl. No.: 13/951,476

(22) Filed: Jul. 26, 2013

(30) Foreign Application Priority Data
Oct. 23, 2012 (CN) 201210408030.7

(51) Int. Cl. G06F 3/044

(52) U.S. Cl. CPC G06F 3/044
USPC 345/174

(57) ABSTRACT

The present invention provides a three-dimensional touch display panel including a display panel and an integrated panel. The integrated panel is disposed on the display panel, and the integrated panel includes a first transparent substrate, a first patterned transparent conductive layer disposed on the first transparent substrate, a second transparent substrate disposed opposite to the first transparent substrate, a second patterned transparent conductive layer disposed between the first transparent substrate and the second transparent substrate, a first plate-shaped transparent conductive layer disposed on the second transparent substrate, and a liquid crystal layer disposed between the first patterned transparent conductive layer and the first transparent conductive layer. The first patterned transparent conductive layer includes a plurality of first electrode stripes sequentially arranged along a first direction. The second patterned transparent conductive layer includes a plurality of second electrode stripes sequentially arranged along a second direction different from the first direction.

### BACKGROUND OF THE INVENTION

1. Field of the Invention

The present invention relates to a three-dimensional touch display panel and a method for operating the same, and more particularly, to a three-dimensional touch display panel having an integrated panel integrated with touch panel and liquid crystal lens panel or parallax barrier panel and a method for operating the same.

2. Description of the Prior Arts

Recently, with the advance of the technology of display, the development and application of the stereoscopic display technology are rose more and more. The principle of the stereoscopic display technology is to make the left eye and the right eye of the observer to receive two different images respectively, and the images received by the left eye and the right eye can overlap each other and be analyzed by the cerebrum, so that the observer can see the depth and gradation of images and sense the stereoscopic image. Furthermore, as the touch panel with touch function has been developed, the application of the touch display panel integrated with the touch panel and the display have increased significantly, for example, mobile phones, GPS navigation systems, tablet PCs, PDAs, and laptop PCs.

In the conventional three-dimensional touch display panel, a touch panel adheres to a display surface of a three-dimensional display panel, so that the conventional three-dimensional touch display panel can have a touch sensing function. However, the conventional three-dimensional touch display panel is formed with a display panel and a parallax barrier panel or formed with a display panel and a liquid crystal lens panel. Thus, the thickness and the weight of the conventional three-dimensional touch display panel are increased when the touch panel adheres to the outside of the three-dimensional display panel. Accordingly, the thickness and the weight of the conventional three-dimensional touch display panel are limited. Furthermore, there still is an inaccuracy when the touch panel adheres to the three-dimensional display panel. Thus, some bad three-dimensional touch display panels are generated, and the manufacturing cost is increased.

Therefore, to reduce the thickness and the weight of the three-dimensional touch display panel to reduce the manufacturing cost is an objective in this field.

### SUMMARY OF THE INVENTION

It is therefore an objective of the present invention to provide a three-dimensional touch display panel and a method for operating the same to reduce the thickness and the weight of the three-dimensional touch display panel and reduce the manufacturing cost.

According to an embodiment, the present invention provides a three-dimensional touch display panel, including a display panel and an integrated panel. The display panel has a display surface and a back surface disposed opposite to the display surface. The integrated panel is disposed on the display surface, and the integrated panel includes a first transparent substrate, a first patterned transparent conductive layer, a second transparent substrate, a second patterned transparent conductive layer, a first plate-shaped transparent conductive layer, and a liquid crystal layer. The first transparent substrate has a first inner surface and a first outer surface. The first patterned transparent conductive layer is disposed on the first inner surface of the first transparent substrate, and the first patterned transparent conductive layer includes a plurality of first electrode stripes sequentially arranged along a first direction. The second transparent substrate has a second inner surface and a second outer surface, and the first inner surface faces the second inner surface, wherein the first transparent substrate and the second transparent substrate have no substrates disposed therebetween. The second patterned transparent conductive layer is disposed between the first transparent substrate and the second transparent substrate, and the second patterned transparent conductive layer includes a plurality of second electrode stripes sequentially arranged along a second direction different from the first direction. The first plate-shaped transparent conductive layer is disposed on the second inner surface of the second transparent substrate. The liquid crystal layer is disposed between the first patterned transparent conductive layer and the first plate-shaped transparent conductive layer.

According to an embodiment, the present invention provides a method for operating a three-dimensional touch display panel. First, the three-dimensional touch display panel is provided. The three-dimensional touch display panel includes a display panel and an integrated panel, and the integrated panel includes a first transparent substrate, a first patterned transparent conductive layer, a second transparent substrate, a second patterned transparent conductive layer, a first plate-shaped transparent conductive layer, and a liquid crystal layer. The first transparent substrate has a first inner surface and a first outer surface. The first patterned transparent conductive layer is disposed on the first inner surface of the first transparent substrate, and the first patterned transparent conductive layer includes a plurality of first electrode stripes sequentially arranged along a first direction. The second transparent substrate has a second inner surface and a second outer surface, and the first inner surface faces the second inner surface, wherein the first transparent substrate and the second transparent substrate have no substrates disposed therebetween. The second patterned transparent conductive layer is disposed between the first transparent substrate and the second transparent substrate, and the second patterned transparent conductive layer includes a plurality of second electrode stripes sequentially arranged along a second direction different from the first direction. The first plate-shaped transparent conductive layer is disposed on the second inner surface of the second transparent substrate. The liquid crystal layer is disposed between the first patterned transparent conductive layer and the first plate-shaped transparent conductive layer. Then, a three-dimensional image signal is transmitted to the display panel. Next, a plurality of integrated timing signals are sequentially transmitted to the first patterned transparent conductive layer or the second patterned transparent conductive layer, so that the three-dimensional touch display panel displays a three-dimensional image, wherein each integrated timing signal includes a touch sensing time period and a three-dimensional displaying time period, and each touch sensing time period does not overlap each three-dimensional display time period, wherein each touch sensing time period is ranged from 10 microseconds to 100 microseconds, and each three-dimensional displaying time period is ranged from 4 milliseconds to 1 second.

The touch panel and the liquid crystal lenses of the integrated panel are integrated into one panel in the present invention. Thus, the integrated panel only requires two substrates, and the integrated panel can have both the function of touch sensing and the function of liquid crystal lenses. Accordingly, the substrate of the touch panel can be effectively saved in the three-dimensional touch display panel, and the thickness and the weight of the three-dimensional touch display panel can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a three-dimensional touch display panel according to a first embodiment of the present invention.

FIG. 2 is a schematic diagram illustrating the integrated panel according to the first embodiment of the present invention.

FIG. 3 is a schematic diagram illustrating a three-dimensional touch display panel according to a second embodiment of the present invention.

FIG. 4 is a schematic diagram illustrating a three-dimensional touch display panel according to a third embodiment of the present invention.

FIG. 5 is a schematic diagram illustrating a three-dimensional touch display panel according to a fourth embodiment of the present invention.

FIG. 6 is a schematic diagram illustrating a three-dimensional touch display panel according to a fifth embodiment of the present invention.

FIG. 7 is a schematic diagram illustrating a three-dimensional touch display panel according to a sixth embodiment of the present invention.

FIG. 8 is a schematic diagram illustrating a three-dimensional touch display panel according to a seventh embodiment of the present invention.

FIG. 9 is a flow chart of a method for operating the three-dimensional touch display panel according to an embodiment of the present invention.

FIG. 10 illustrates an electrical connection method of the first electrode stripes according to the embodiment of the present invention.

FIG. 11 is a timing diagram illustrating an integrated timing signal according to the present invention.

### DETAILED DESCRIPTION

To provide a better understanding of the present invention, exemplary embodiments will be detailed as follows. The exemplary embodiments of the present invention are illustrated in the accompanying drawings with numbered elements to elaborate the contents and effects to be achieved.

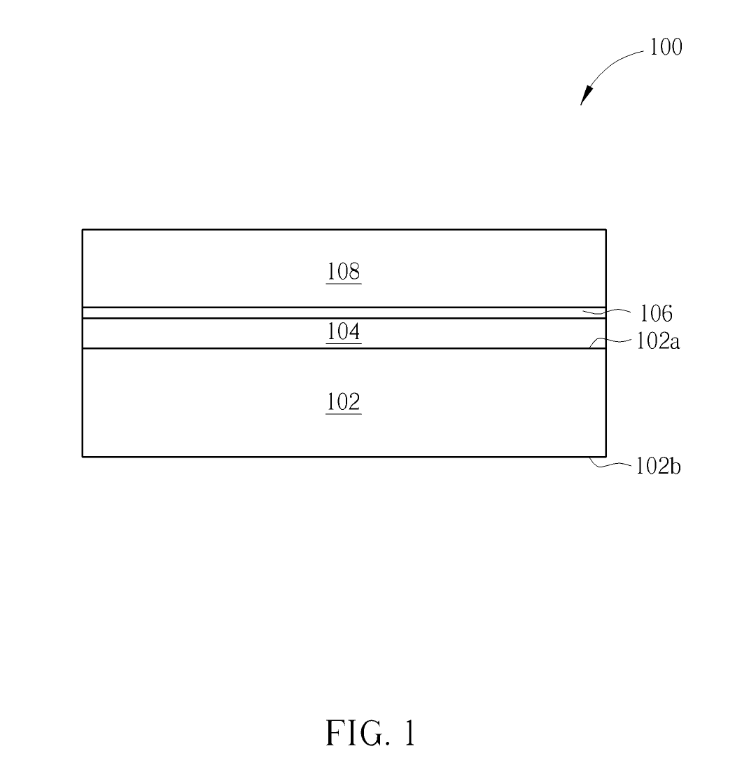

Please refer to FIG. 1, which is a schematic diagram illustrating a three-dimensional touch display panel according to a first embodiment of the present invention. As shown in FIG. 1, the three-dimensional touch display panel 100 in this embodiment includes a display panel 102, a first polarizer 104, an adhesive layer 106, and an integrated panel 108. The display panel 102 has a display surface 102a and a back surface 102b, in which the display surface 102a and the back surface 102b are disposed opposite to each other. The display panel 102 is configured to display a frame with different viewing-angle image signals. In this embodiment, the display panel 102 is an active type self-emission display panel, such as organic light-emitting diode display panel, but the present invention is not limited thereto. Furthermore, the integrated panel 108 in this embodiment is disposed on the display surface 102a of the display panel 102. The integrated panel 108 may serve as a liquid crystal lens panel having a function of liquid crystal lenses, so that the integrated panel 108 can divide the frame with different viewing-angle image signals into two different viewing angle images, such as left eye image and right eye image. The different viewing angle images can emit toward different viewing angles, and the viewing angle images can form a three-dimensional image. Also, the integrated panel 108 further has a touch-sensing function. The first polarizer 104 is disposed on the display surface 102a of the display panel 102 and between the integrated panel 108 and the display panel 102, and is configured to polarize light generated from the display panel 102. The adhesive layer 106 is disposed between the first polarizer 104 and the integrated panel 108 and used to stick the integrated panel 108 on the display panel 102. The adhesive layer 106 is formed with adhesive material, such as optical clear adhesive, square adhesive or liquid type optical glue.

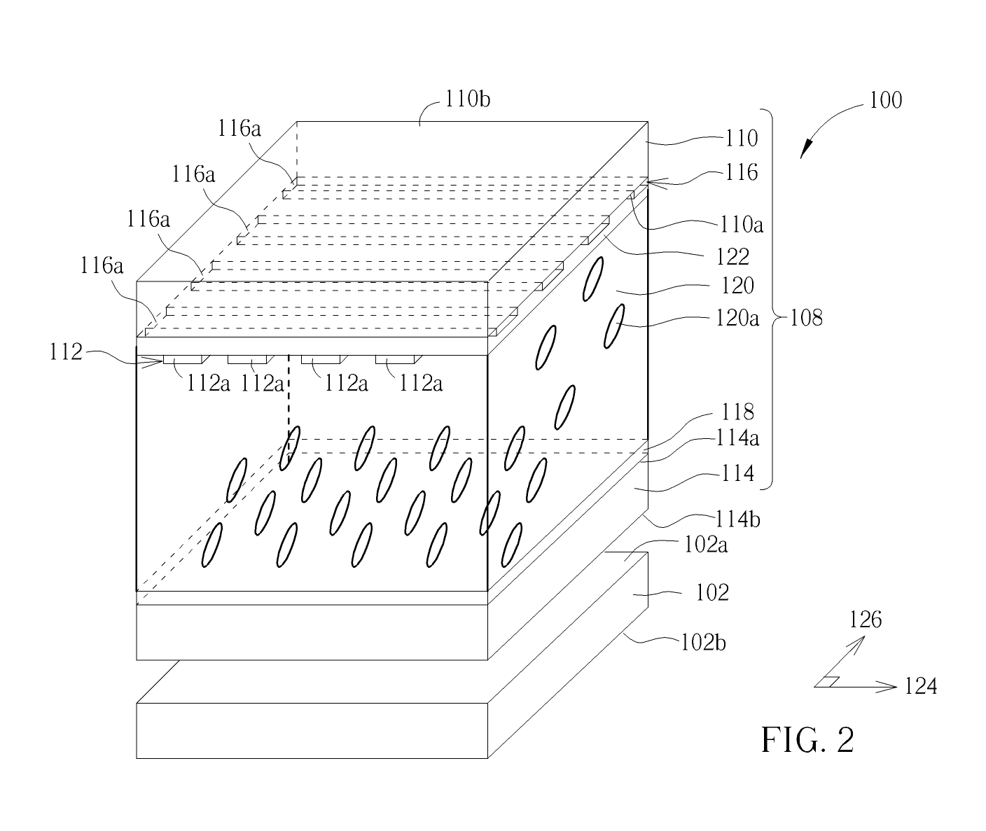

The integrated panel 108 in this embodiment will be detailed in the following description. Please refer FIG. 2 together with FIG. 1. FIG. 2 is a schematic diagram illustrating the integrated panel according to the first embodiment of the present invention. As shown in FIG. 1 and FIG. 2, the integrated panel 108 includes a first transparent substrate 110, a first patterned transparent conductive layer 112, a second transparent substrate 114, a second patterned transparent conductive layer 116, a first plate-shaped transparent conductive layer 118, and a liquid crystal layer 120. The first transparent substrate 110 has a first inner surface 110a and a first outer surface 110b, and the first transparent substrate 110 and the second transparent substrate 114 are disposed opposite to each other. The second transparent substrate 114 has a second inner surface 114a and a second outer surface 114b, and the first inner surface 110a of the first transparent substrate 110 faces the second inner surface 114a of the second transparent substrate 114. The first transparent substrate 110 and the second transparent substrate 114 may be formed with transparent substrates, such as glass, quartz or plastic. The liquid crystal layer 120 is disposed between the first transparent substrate 110 and the second transparent substrate 114, and the liquid crystal layer 120 includes a plurality of liquid crystal molecules 120a, such as twisted nematic (TN) liquid crystal. In this embodiment, the second outer surface 114b of the second transparent substrate 114 faces the display surface 102a of the display panel 102. Furthermore, the first patterned transparent conductive layer 112 and the second patterned transparent conductive layer 116 are disposed on the first inner surface 110a of the first transparent substrate 110 and between the first transparent substrate 110 and the liquid crystal layer 120. The second patterned transparent conductive layer 116 is disposed between the first patterned transparent conductive layer 112 and the first transparent substrate 110. The first plate-shaped transparent conductive layer 118 is disposed on the second inner surface 114a of the second transparent substrate 114. The liquid crystal layer 120 is disposed between the first plate-shaped transparent conductive layer 118 and the first patterned transparent conductive layer 112, so that the liquid crystal molecules 120a can be rotated with a voltage difference applied between the first plate-shaped transparent conductive layer 118 and the first patterned transparent conductive layer 112 and form liquid crystal lenses. The first patterned transparent conductive layer 112, the second patterned transparent conductive layer 116 and the first plate-shaped transparent conductive layer 118 can be formed with transparent conductive materials, such as indium tin oxide, indium zinc oxide, aluminum tin oxide or aluminum zinc oxide. The integrated panel 108 further includes an insulating layer 122 disposed between the first patterned transparent conductive layer 112 and the second patterned transparent conductive layer 116. It should be noted that the first transparent substrate 110 and the second transparent substrate 114 have no substrates disposed therebetween. This is to say that only the first transparent substrate 110 and the second transparent substrate 114 are the substrates used to form the first patterned transparent conductive layer 112, the second patterned transparent conductive layer 116 and the first plate-shaped transparent conductive layer 118 in the integrated panel 108.

In addition, the first patterned transparent conductive layer 112 includes a plurality of first electrode stripes 112a sequentially arranged along a first direction 124, in which the first electrode stripes 112a may serve as touch sensing electrodes and may be used to sense a position of a touch object in the first direction 124. The second patterned transparent conductive layer 116 includes a plurality of second electrode stripes 116a sequentially arranged along a second direction 126 different from the first direction 124, in which the second electrode stripes 116a cross the first electrode stripes 112a. The second electrode stripes 116a serve as touch sensing electrodes and may be used to sense a position of the touch object in the second direction 126. The first direction 124 and the second direction 126 are preferably perpendicular to each other, and the first electrode stripes 112a and the second electrode stripes 116a are perpendicular to each other. In this embodiment, the first direction 124 is the same as a horizontal direction of the frame displayed by the display panel 102, so that the first electrode stripes 112a are substantially perpendicular to the horizontal direction of the frame displayed by the display panel 102. Accordingly, the first electrode stripes 112a can serve as electrodes of the liquid crystal lens panel. When a voltage difference is applied between the first electrode stripes 112a and the first plate-shaped transparent conductive layer 118, the liquid crystal layer 120 can form a plurality pillared liquid crystal lenses, and a pillar direction of each pillared liquid crystal lens is substantially perpendicular to the horizontal direction of the frame. As the above-mentioned description, the first transparent substrate 110, the second electrode stripes 116a, the insulating layer 122 and the first electrode stripes 112a can form a touch panel, and the first transparent substrate 110, the first electrode stripes 112a, the liquid crystal layer 120, the first plate-shaped transparent conductive layer 118 and the second transparent substrate 114 can form a liquid crystal lens panel. In other words, the integrated panel 108 in this embodiment not only uses the first electrode stripes 112a and the second electrode stripes 116a to perform the touch sensing function, but also uses the first electrode stripes 112a, the liquid crystal layer 120 and the first plate-shaped transparent conductive layer 118 to perform the function of the liquid crystal lenses. Thus, in the integrated panel 108 of this embodiment, the touch panel and the liquid crystal lens panel are integrated to be a single panel, and only two substrates are required to both have the touch-sensing function and the function of the liquid crystal lenses. As compared with the three-dimensional touch display panel having the touch panel adhering to the outside of the three-dimensional display panel, the substrate of the touch panel can be saved in the three-dimensional touch display panel 100, and the thickness and the weight of the three-dimensional touch display panel 100 can be effectively reduced in this embodiment. Furthermore, the first patterned transparent conductive layer 112 and the second patterned transparent conductive layer 116 are directly formed on the first transparent substrate 110 in the integrated panel 108 of this embodiment, so that the position of the touch panel and the position of the liquid crystal lenses can be accurately aligned, and no processes for sticking the touch panel on the three-dimensional display panel is required. No risks of bad products generated by sticking the touch panel on the three-dimensional display panel inaccurately exist, and the manufacturing cost is reduced accordingly.

It should be noted that the liquid crystal layer 120 not only is disposed between the first electrode stripes 112a and the first plate-shaped transparent conductive layer 118, but also is disposed between the second electrode stripes 116a and the first plate-shaped transparent conductive layer 118. Thus, when the horizontal direction of the frame displayed by the display panel 102 is rotated 90 degrees to be the same as the second direction, the second electrode stripes 116a, the liquid crystal layer 120 and the first plate-shaped transparent conductive layer 118 also can form the pillared liquid crystal lenses, and the pillar directions of the pillared liquid crystal lenses are substantially parallel to the second direction 126. Accordingly, the three-dimensional image also can be displayed. Therefore, when the three-dimensional touch display panel 100 is rotated by 90 degrees, and the vertical direction and the horizontal direction of the frame are not rotated, the three-dimensional touch display panel 100 still can display the three-dimensional image. In other embodiment of the present invention, the second direction also can be the same as the horizontal direction of the frame displayed by the display panel.

The three-dimensional touch display panel of the present invention is not limited to the above-mentioned embodiment. The following description continues to detail the other embodiments or modifications, and in order to simplify and show the difference between the other embodiments or modifications and the above-mentioned embodiment, the same numerals denote the same components in the following description, and the same parts are not detailed redundantly.

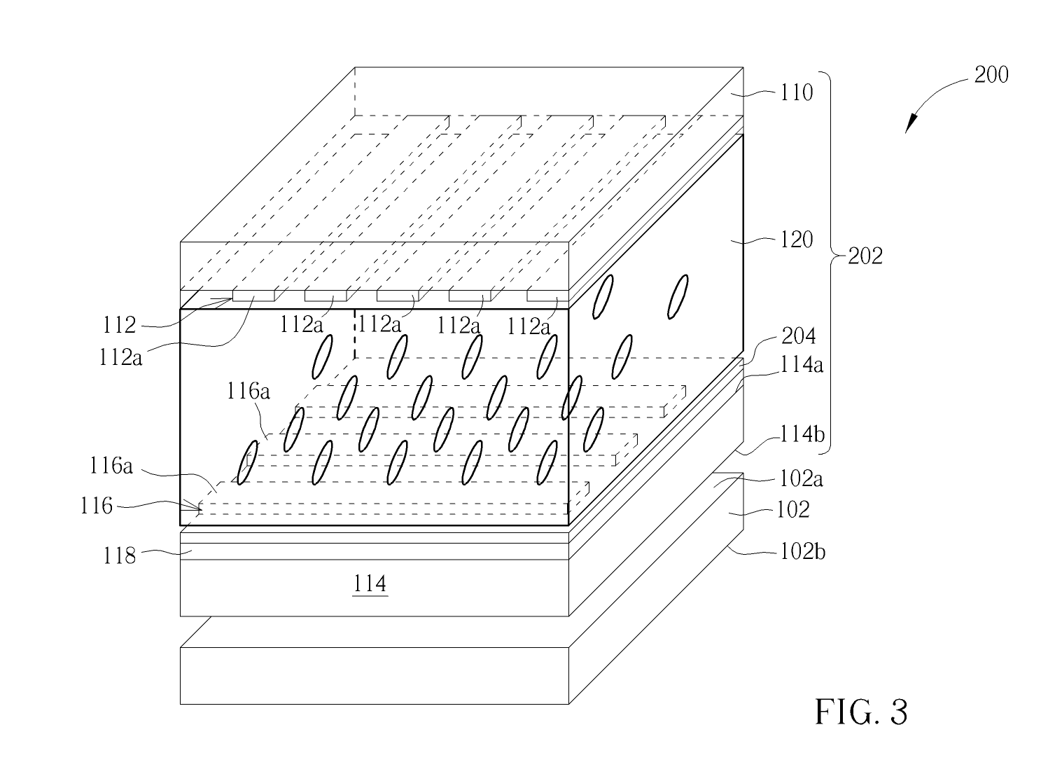

Please refer to FIG. 3, which is a schematic diagram illustrating a three-dimensional touch display panel according to a second embodiment of the present invention. As shown in FIG. 3, as compared with the first embodiment, the second patterned transparent conductive layer 116 of the integrated panel 202 is disposed between the first plate-shaped transparent conductive layer 118 and the liquid crystal layer 120, and the first patterned transparent conductive layer 112 and the first transparent substrate 110 have no insulating layers disposed therebetween in this embodiment. Furthermore, the integrated panel 202 in this embodiment further includes a first insulating layer 204 disposed between the second patterned transparent conductive layer 116 and the first plate-shaped transparent conductive layer 118 and used to electrically insulate the second patterned transparent conductive layer 116 from the first plate-shaped transparent conductive layer 118. In this embodiment, when the liquid crystal layer 120 is driven with a voltage difference applied between the first patterned transparent conductive layer 116 and the first plate-shaped transparent conductive layer 118 to form the liquid crystal lenses, the first patterned transparent conductive layer 112 and the second patterned transparent conductive layer 116 can further serve as touch-sensing electrodes. Moreover, the first direction 124 should be the same as the horizontal direction of the frame displayed by the display panel 102 in this embodiment, so that the first patterned transparent conductive layer 112 can be used to drive the liquid crystal molecules 120a to form the liquid crystal lenses. Accordingly, the three-dimensional touch display panel 200 in this embodiment can display the three-dimensional image.

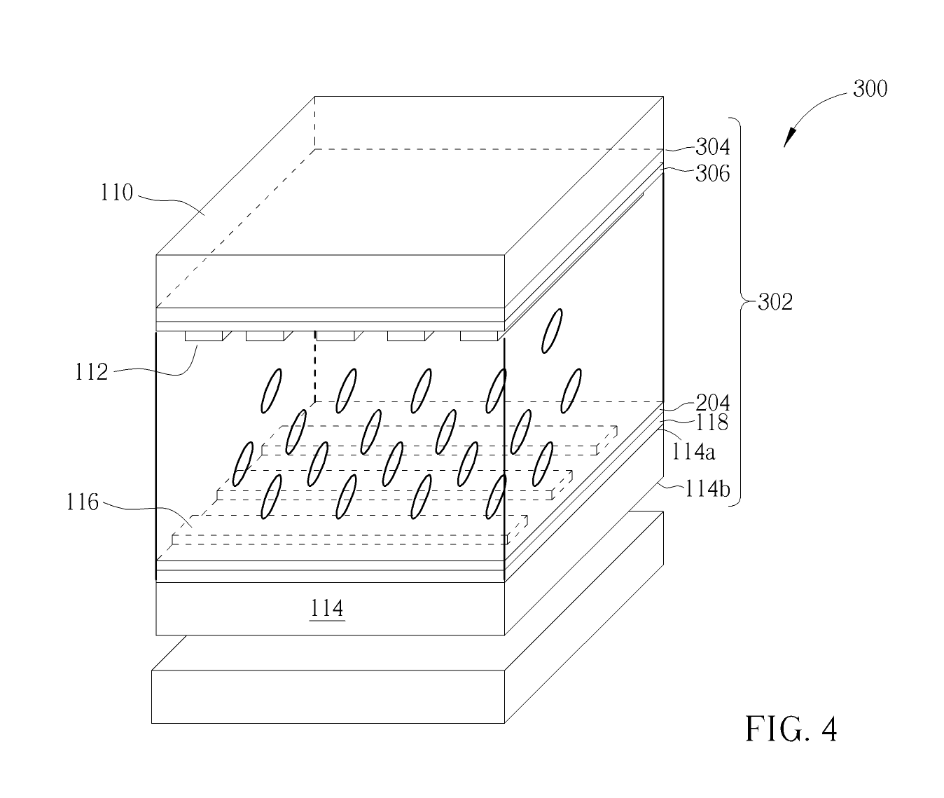

Please refer to FIG. 4, which is a schematic diagram illustrating a three-dimensional touch display panel according to a third embodiment of the present invention. As shown in FIG. 4, as compared with the second embodiment, the integrated panel 302 of the three-dimensional touch display panel 300 in this embodiment further includes a second plate-shaped transparent conductive layer 304 and a second insulating layer 306. The second plate-shaped transparent conductive layer 304 is disposed on the first inner surface 110a of the first transparent substrate 110 and between the first patterned transparent conductive layer 112 and the first transparent substrate 110. The second insulating layer 306 is disposed between the second plate-shaped transparent conductive layer 304 and the first patterned transparent conductive layer 112 and used to electrically insulate the second plate-shaped transparent conductive layer 304 from the first patterned transparent conductive layer 112. In this embodiment, when a voltage difference is applied between the first patterned transparent conductive layer 112 and the first plate-shaped transparent conductive layer 118 or applied between the second patterned transparent conductive layer 116 and the second plate-shaped transparent conductive layer 304, the liquid crystal molecules 120a of the liquid crystal layer 120 can be driven to form the liquid crystal lenses, and the first patterned transparent conductive layer 112 and the second patterned transparent conductive layer 116 can serve as touch-sensing electrodes at the same time. It should be noted that the liquid crystal layer 120 is not only disposed between the first electrode stripes 112a and the first plate-shaped transparent conductive layer 118, but also between the second electrode stripes 116a and the first plate-shaped transparent conductive layer 118. Thus, when the three-dimensional touch display panel 300 is rotated by 90 degrees, and the vertical direction and the horizontal direction of the frame are not rotated, the three-dimensional touch display panel 300 still can display the three-dimensional image.

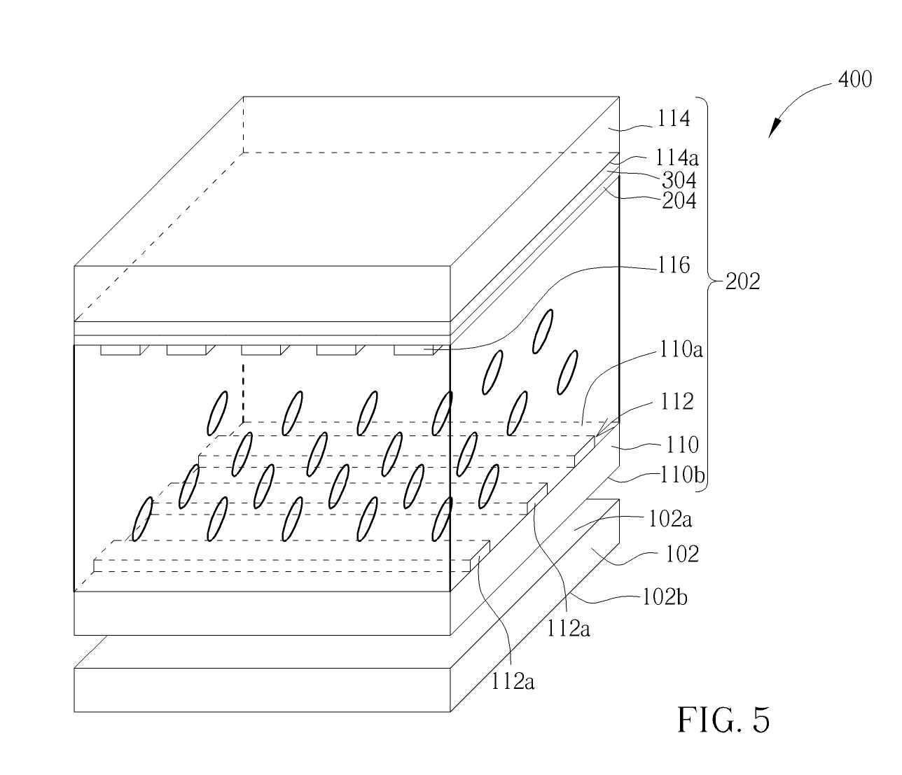

Please refer to FIG. 5, which is a schematic diagram illustrating a three-dimensional touch display panel according to a fourth embodiment of the present invention. As shown in FIG. 5, as compared with second embodiment, the first outer surface 110b of the first transparent substrate 110 of the integrated panel 402 faces the display surface 102a of the display panel 102 in the three-dimensional touch display panel 400 of this embodiment. Accordingly, the first transparent substrate 110 is disposed between the second transparent substrate 114 and the display panel 102. Also, the second patterned transparent conductive layer 116 is disposed on the second inner surface 114a of the second transparent substrate 114 and between the first plate-shaped transparent conductive layer 118 and the liquid crystal layer 120. In this embodiment, the first patterned transparent conductive layer 112 and the first transparent substrate 110 have no insulating layers disposed therebetween.

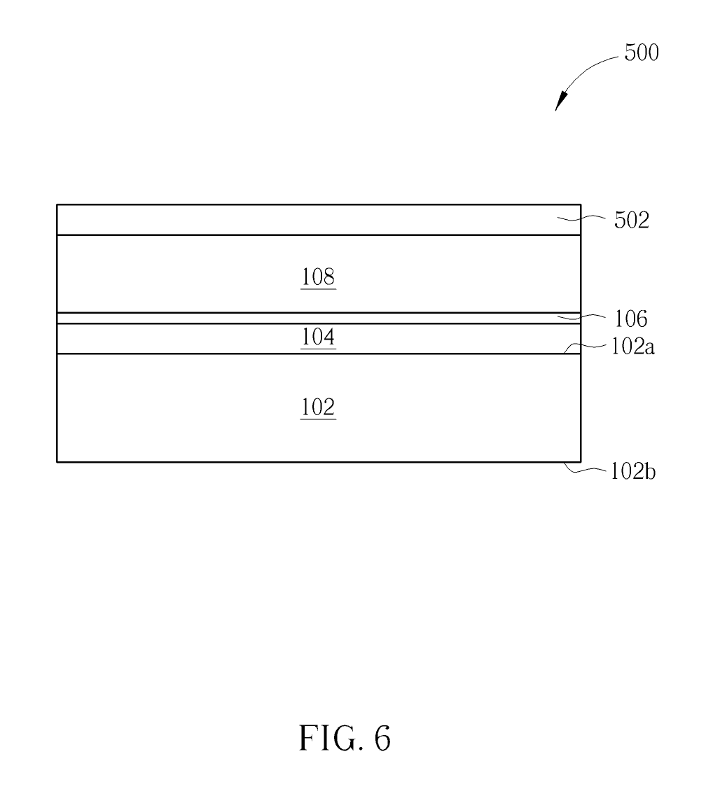

Please refer to FIG. 6, which is a schematic diagram illustrating a three-dimensional touch display panel according to a fifth embodiment of the present invention. As shown in FIG. 6, as compared with first embodiment, the three-dimensional touch display panel 500 in this embodiment further includes a second polarizer 502 disposed on the outside of the integrated panel 108. Accordingly, the integrated panel 108 is disposed between the first polarizer 106 and the second polarizer 502. In this embodiment, the integrated panel 108 serves as a parallax barrier panel and is used to form parallax barriers. The polarization direction of the first polarizer 106 is perpendicular to the polarization direction of the second polarizer 502, so that the integrated panel 108 can display a bright state and a dark state. In other embodiments of the present invention, the structure of the integrated panel also can be any one of the integrated panels of the second embodiment through the fourth embodiment.

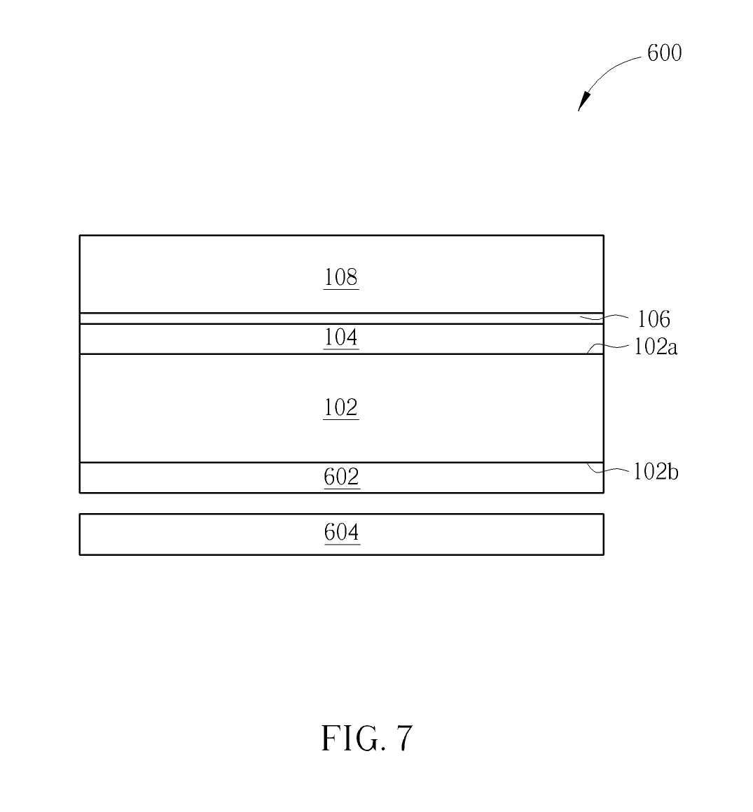

Please refer to FIG. 7, which is a schematic diagram illustrating a three-dimensional touch display panel according to a sixth embodiment of the present invention. As shown in FIG. 7, as compared with first embodiment, the three-dimensional touch display panel 600 of this embodiment further includes a second polarizer 602 and a backlight source 604, in which the display panel 102 is a liquid crystal display panel. The backlight source 604 is disposed on the back surface 102b of the display panel 102. The second polarizer 602 is disposed between the display panel 102 and the backlight source 604. Furthermore, the polarization direction of the first polarizer 104 is perpendicular to the polarization direction of the second polarizer 602, and the frame displayed from the display panel 102 can show a bright state and a dark state accordingly. Furthermore, the integrated panel still serves as a liquid crystal lens panel. Thus, the frame generated from the display surface 102a of the display panel 102 can penetrate through the liquid crystal lenses formed with the integrated panel 108 to display the three-dimensional image. In other embodiment of the present invention, the structure of the integrated panel also can be any one of the integrated panels of the second embodiment through the fourth embodiment.

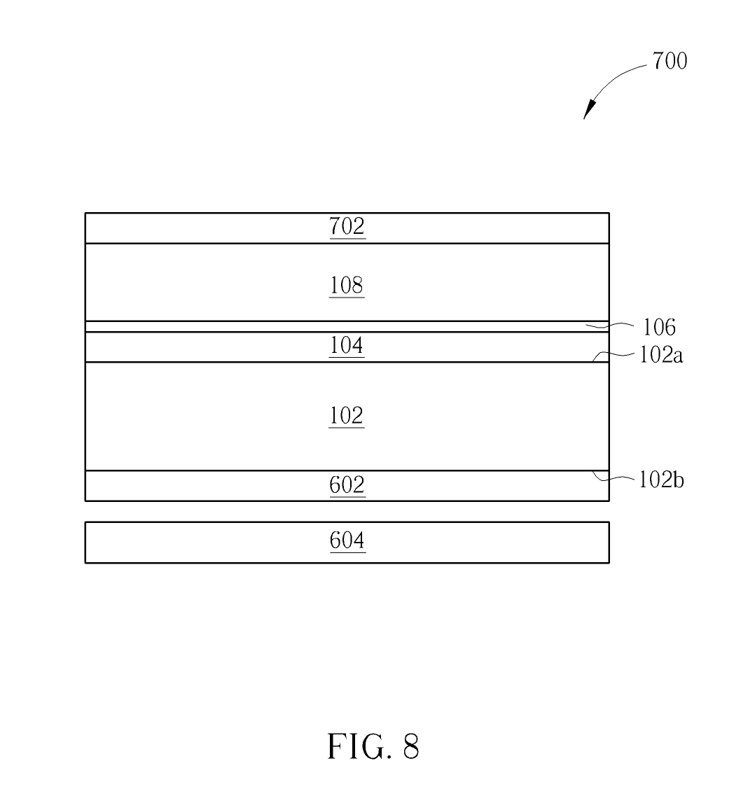

Please refer to FIG. 8, which is a schematic diagram illustrating a three-dimensional touch display panel according to a seventh embodiment of the present invention. As shown in FIG. 8, as compared with first embodiment, the three-dimensional touch display panel 700 includes a three polarizer 702 disposed on the outside of the integrated panel 108, and the integrated panel 108 is disposed between the first polarizer 104 and the third polarizer 702. In this embodiment, the integrated panel 108 serves as a parallax barrier panel and is used to form parallax barriers. The polarization of the first polarizer 104 is perpendicular to the polarization of the third polarizer 702, and the integrated panel 108 can show a bright state and a dark state accordingly. In other embodiment of the present invention, the structure of the integrated panel also can be any one of the integrated panels of the second embodiment through the fourth embodiment.

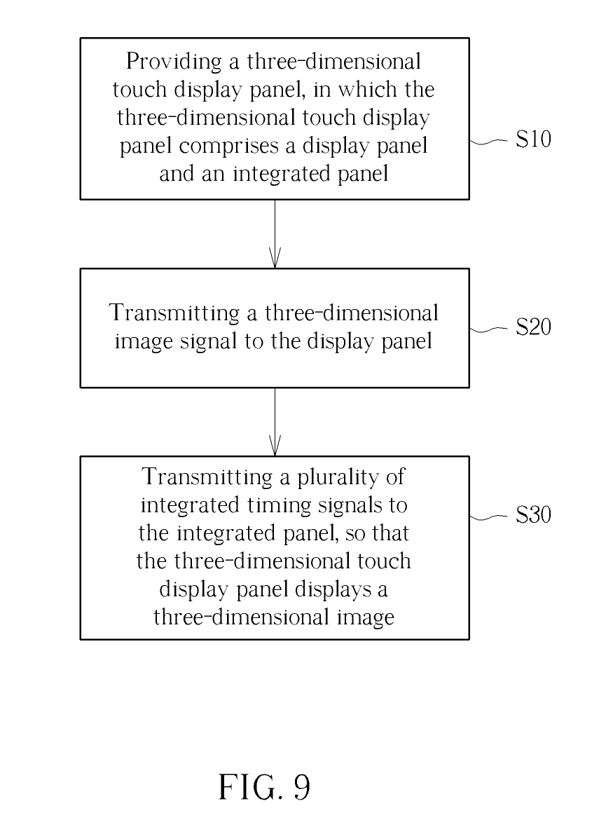

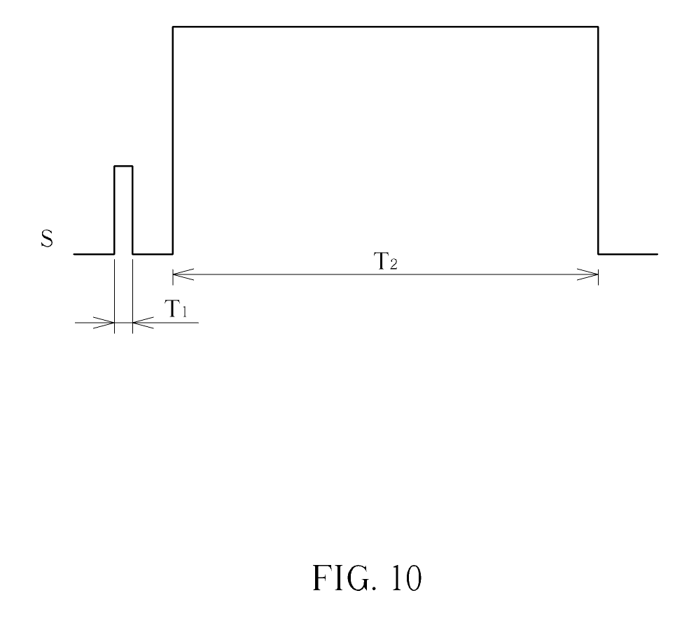

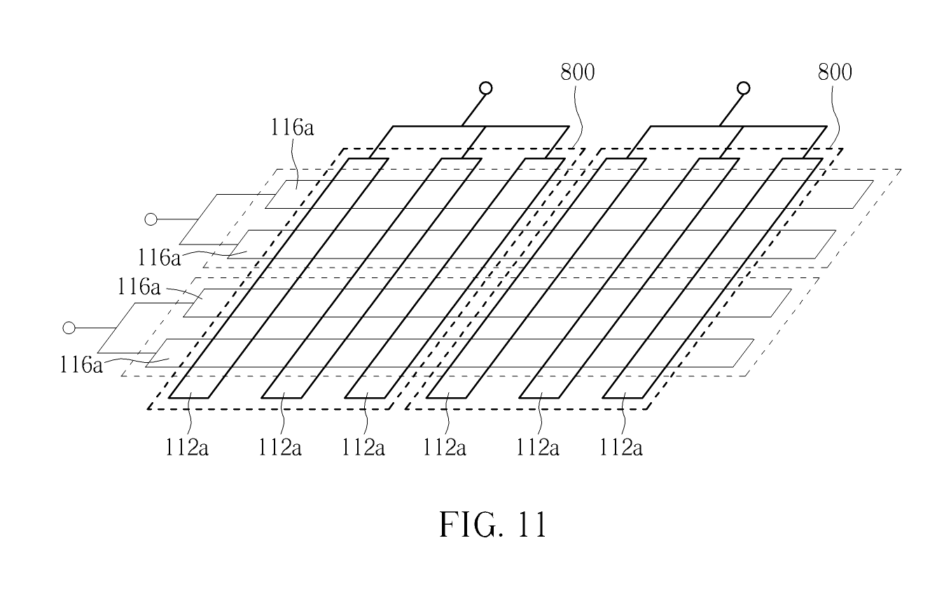

In addition, the present invention further provides a method for operating the three-dimensional touch display panel to show that the integrated panel can provide the touch-sensing function and a function of liquid crystal lenses at the same time. The three-dimensional touch display panel can provide a touch-sensing function while displaying the three-dimensional image. Please refer to FIG. 9 through FIG. 11 together with FIG. 2. FIG. 9 is a flow chart of a method for operating the three-dimensional touch display panel according to an embodiment of the present invention. FIG. 10 illustrates an electrical connection method of the first electrode stripes according to the embodiment of the present invention. FIG. 11 is a timing diagram illustrating an integrated timing signal according to the present invention. The three-dimensional touch display panel in the following description takes the first embodiment as an example, but the present invention is not limited thereto. As shown in FIG. 9, the method for operating the three-dimensional touch display panel 100 in this embodiment includes the following steps:

Step S10: providing a three-dimensional touch display panel 100, in which the three-dimensional touch display panel 100 comprises a display panel 102 and an integrated panel 108;

Step S20: transmitting a three-dimensional image signal to the display panel 102; and

Step S30: transmitting a plurality of integrated timing signals to the integrated panel 108, so that the three-dimensional touch display panel 100 displays a three-dimensional image.

In this embodiment, the three-dimensional touch display panel 100 as revealed in step S10 is the three-dimensional touch display panel according to the first embodiment, but the present invention is not limited thereto. The three-dimensional touch display panel of the present invention also can be any one of the three-dimensional touch display panels according to the above-mentioned embodiments. In Step S20, the three-dimensional image signal is a signal integrated with two viewing angle images, so that the frame displayed by the display panel 102 has two viewing angle images.

As shown in FIG. 10, in Step S30, each integrated timing signals S includes a touch sensing time period T1 and a three-dimensional displaying time period T2, in which each integrated timing signal S in the touch sensing time period T1 is used to sense the touch of the touch object, and each integrated timing signal S in the touch sensing time period T2 is used to form the liquid crystal lenses. Also, each integrated timing signal S in the three-dimensional displaying time period T2 is synchronized with the three-dimensional image signal transmitted to the display panel 102, so that the liquid crystal lenses and the frame displayed by the display panel 102 can be combined to display the three-dimensional image. It should be noted that each touch sensing time period T1 does not overlap each three-dimensional displaying time period T2. Thus, the action of the integrated panel 108 performing the touch-sensing function does not affect the action of the integrated panel 108 performing the function of the liquid crystal lenses. In this embodiment, each touch sensing time period T1 is ranged from 10 microseconds to 100 microseconds, and each three-dimensional displaying time period T2 is ranged from 4 milliseconds and 1 second. Accordingly, the sum of each touch sensing time period T1 and each three-dimensional displaying time period T2 will not be larger than a visual persistence time of the human eye. The three-dimensional displaying time period T2 can be adjusted according to the type of the liquid crystal molecules 120a in the liquid crystal layer 120.

In this embodiment, the three-dimensional touch display panel 100 operates in a capacitive touch sensing method, in which the integrated timing signals S are transmitted to the first patterned transparent conductive layer 112, and then, a control device is used to received the signals generated from the second patterned transparent conductive layer 116 sensing the integrated timing signals S so that the function of touch sensing is achieved. As shown in FIG. 10, every three of the first electrode stripes 112a form a first sensing group 800 and are electrically connected to one another. Every two of the second electrode stripes 116a form a second sensing group 802 and are electrically connected to one another. The integrated timing signals S are sequentially transmitted to the first sensing groups 800, and the signals generated from the second sensing groups 80 sensing the integrated timing signals S respectively can be received with the control device.

In other embodiment of the present invention, the integrated timing signals in the touch sensing time periods also can be transmitted to the second patterned transparent conductive layer, and the control device receives the signals generated from the first patterned transparent conductive layer sensing the integrated timing signals. Furthermore, the first sensing group can be formed with at least one first electrode stripe, and the second sensing group can be formed with at least one second electrode stripe. The overlapping area of the first sensing group and the second sensing group can be determined according to the actual requirements.

In conclusion, the touch panel and the liquid crystal lenses of the integrated panel are integrated into one panel in the present invention. Thus, the integrated panel only requires two substrates, and the integrated panel can have both the touch-sensing function and the function of liquid crystal lenses. Accordingly, the substrate of the touch panel can be effectively saved in the three-dimensional touch display panel, and the thickness and the weight of the three-dimensional touch display panel can be reduced. Moreover, the first patterned transparent conductive layer and the second patterned transparent conductive layer are directly formed on the first transparent substrate or the second transparent substrate. Thus, the position of the touch panel and the position of the liquid crystal lenses can be accurately aligned, and no processes for sticking the touch panel on the three-dimensional display panel is required. No risks of bad products generated by sticking the touch panel on the three-dimensional display panel inaccurately exist, and the manufacturing cost is reduced accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A three-dimensional touch display panel, comprising:
a display panel having a display surface and a back surface, the back surface being disposed opposite to the display surface; and
an integrated panel disposed on the display surface, and the integrated panel comprising:
a first transparent substrate having a first inner surface and a first outer surface;
a first patterned transparent conductive layer disposed on the first inner surface of the first transparent substrate, and the first patterned transparent conductive layer comprising a plurality of first electrode stripes sequentially arranged along a first direction;
a second transparent substrate having a second inner surface and a second outer surface, wherein the first inner surface faces the second inner surface, and the first transparent substrate and the second transparent substrate have no substrates disposed therebetween;
a second patterned transparent conductive layer disposed between the first transparent substrate and the second transparent substrate, and the second patterned transparent conductive layer comprising a plurality of second electrode stripes sequentially arranged along a second direction different from the first direction;
a first plate-shaped transparent conductive layer disposed on the second inner surface of the second transparent substrate; and
a liquid crystal layer disposed between the first patterned transparent conductive layer and the first plate-shaped transparent conductive layer.

2. The three-dimensional touch display panel according to claim 1, wherein the second outer surface of the second transparent substrate faces the display surface of the display panel.

3. The three-dimensional touch display panel according to claim 2, wherein the second patterned transparent conductive layer is disposed between the first patterned transparent conductive layer and the first transparent substrate, and the integrated panel further comprises an insulating layer disposed between the first patterned transparent conductive layer and the second patterned transparent conductive layer and used to electrically insulate the second patterned transparent conductive layer from the first patterned transparent conductive layer.

4. The three-dimensional touch display panel according to claim 2, wherein the second patterned transparent conductive layer is disposed between the first plate-shaped transparent conductive layer and the liquid crystal layer, and the integrated panel further comprises a first insulating layer disposed between the second patterned transparent conductive layer and the first plate-shaped transparent conductive layer and used to electrically insulate the second patterned transparent conductive layer from the first plate-shaped transparent conductive layer.

5. The three-dimensional touch display panel according to claim 4, wherein the integrated panel further comprises a second plate-shaped transparent conductive layer and a second insulating layer, wherein the second plate-shaped transparent conductive layer is disposed between the first patterned transparent conductive layer and the first transparent substrate, and the second insulating layer is disposed between the first patterned transparent conductive layer and the second plate-shaped transparent conductive layer and used to electrically insulate the second plate-shaped transparent conductive layer from the first patterned transparent conductive layer.

6. The three-dimensional touch display panel according to claim 1, wherein the first outer surface of the first transparent substrate faces the display surface of the display panel.

7. The three-dimensional touch display panel according to claim 6, wherein the second patterned transparent conductive layer is disposed between the first plate-shaped transparent conductive layer and the liquid crystal layer, and the integrated panel further comprises an insulating layer disposed between the second patterned transparent conductive layer and the first plate-shaped transparent conductive layer and used to electrically insulate the second patterned transparent conductive layer from the first plate-shaped transparent conductive layer.

8. The three-dimensional touch display panel according to claim 1, wherein the display panel is an organic light emitting diode display panel, and the three-dimensional touch display panel further comprises a first polarizer disposed between the integrated panel and the display panel.

9. The three-dimensional touch display panel according to claim 8, further comprising a second polarizer, wherein the integrated panel is disposed between the first polarizer and the second polarizer.

10. The three-dimensional touch display panel according to claim 1, wherein the display panel is a liquid crystal display panel, and the three-dimensional touch display panel further comprises a first polarizer and a second polarizer disposed on the display surface and the back surface of the display panel respectively.

11. The three-dimensional touch display panel according to claim 10, further comprising a third polarizer, wherein the integrated panel is disposed between the first polarizer and the third polarizer.

12. A method for operating a three-dimensional touch display panel, comprising:
providing the three-dimensional touch display panel, the three-dimensional touch display panel comprising a display panel and an integrated panel, and the integrated panel comprising:
a first transparent substrate having a first inner surface and a first outer surface;
a first patterned transparent conductive layer disposed on the first inner surface of the first transparent substrate, and the first patterned transparent conductive layer comprising a plurality of first electrode stripes sequentially arranged along a first direction;
a second transparent substrate having a second inner surface and a second outer surface, and the first inner surface facing the second inner surface, wherein the first transparent substrate and the second transparent substrate have no substrates disposed therebetween;
a second patterned transparent conductive layer disposed between the first transparent substrate and the second transparent substrate, and the second patterned transparent conductive layer comprising a plurality of second electrode stripes sequentially arranged along a second direction different from the first direction;
a first plate-shaped transparent conductive layer disposed on the second inner surface of the second transparent substrate; and
a liquid crystal layer disposed between the first patterned transparent conductive layer and the first plate-shaped transparent conductive layer;
transmitting a three-dimensional image signal to the display panel; and
transmitting a plurality of integrated timing signals to the first patterned transparent conductive layer or the second patterned transparent conductive layer, so that the three-dimensional touch display panel displays a three-dimensional image, wherein each integrated timing signal includes a touch sensing time period and a three-dimensional displaying time period, and each touch sensing time period does not overlap each three-dimensional display time period, wherein each touch sensing time period is ranged from 10 microseconds to 100 microseconds, and each three-dimensional displaying time period is ranged from 4 milliseconds to 1 second.

13. The method for operating the three-dimensional touch display panel according to claim 12, wherein at least one of the first electrode stripes forms a sensing group, and the integrated timing signals are transmitted to the sensing groups respectively.
